(19) United States
(12) Patent Application Publication
(10) Pub. No.: US 2013/0292028 A1
(43) Pub. Date: Nov. 7, 2013

(54) TIRE, THE CARCASS REINFORCEMENT OF WHICH IS REINFORCED WITH A LAYER OF REINFORCING ELEMENTS IN THE BEAD REGION

(71) Applicants: Gilles Sallaz, Clermont-Ferrand Cedex 9 (FR); Agnès Degeorges, Clermont-Ferrand Cedex 9 (FR); Alain Domingo, Clermont-Ferrand Cedex 9 (FR); Sébastien Noel, Clermont-Ferrand Cedex 9 (FR)

(72) Inventors: Gilles Sallaz, Clermont-Ferrand Cedex 9 (FR); Agnès Degeorges, Clermont-Ferrand Cedex 9 (FR); Alain Domingo, Clermont-Ferrand Cedex 9 (FR); Sébastien Noel, Clermont-Ferrand Cedex 9 (FR)

(73) Assignees: Michelin Recherche Et Technique S.A., Granges-Paccot (CH); Compagnie Generale Des Etablissements Michelin, Clermont-Ferrand (FR)

(21) Appl. No.: 13/995,103

(22) PCT Filed: Dec. 20, 2011
(86) PCT No.: PCT/EP2011/073406

§ 371 Date: Jul. 25, 2013

(30) Foreign Application Priority Data
Dec. 21, 2010 (FR) 1060881

(51) Int. Cl. B60C 9/02

(52) U.S. Cl. CPC B60C 9/02
USPC 152/555

(57) ABSTRACT

The invention relates to a tire having a radial carcass reinforcement, consisting of at least one layer of reinforcing elements anchored in each of the beads by an upturn around a bead wire, said carcass reinforcement upturn being reinforced by at least one layer of reinforcing elements or stiffener. According to the invention, the reinforcing elements of at least one stiffener are non-wrapped metal cords with saturated layers, having, in what is called the permeability test, a flow rate of less than 5 cm³/min and the thickness of the polymer blends separating the stiffener from the end of the carcass reinforcement upturn is strictly less than 3.5 mm.

### BACKGROUND

1. Field

The present invention relates to a tire having a radial carcass reinforcement and more particularly to a tire intended to equip heavy-goods vehicles running at sustained speed, such as, for example, lorries, tractors, trailers or buses.

2. Description of Related Art

In general in heavy-goods vehicle tires, the carcass reinforcement is anchored on either side in the region of the bead and is surmounted radially by a crown reinforcement consisting of at least two superposed layers formed from threads or cords that are parallel in each layer and crossed from one layer to the next, making angles of between 10° and 45° with the circumferential direction. Said working layers, forming the working reinforcement, may further be covered with at least one layer referred to as protective layer formed from advantageously extensible metal reinforcing elements, referred to as elastic elements. It may also comprise a layer of low-extensibility metal threads or cords making an angle of between 45° and 90° with the circumferential direction, this ply, referred to as triangulation ply, being located radially between the carcass reinforcement and the first crown ply referred to as the working ply, these being formed from parallel threads or cords at angles of at most equal to 45° in absolute value. The triangulation ply forms, with at least said working ply, a triangulated reinforcement which undergoes, when subjected to the various stresses, little deformation, the essential role of the triangulation ply being to take up the transverse compressive forces to which all of the reinforcing elements in the crown region of the tire are subjected.

Such tires also customarily comprise, at the beads, one or more layers of reinforcing elements referred to as stiffeners. These layers usually consist of reinforcing elements oriented, with respect to the circumferential direction, at an angle of less than 45°, and usually less than 25°. These layers of reinforcing elements have in particular the role of limiting the longitudinal displacements of the constituent materials of the bead with respect to the rim of the wheel to limit premature wear of said bead. They also make it possible to limit the permanent deformation of the bead on the rim flange, due to the phenomenon of dynamic flow of the elastomeric materials; this deformation of the bead may prevent the retreading of the tires when it is excessive. They also contribute to the protection of the low regions of the tire against the stresses experienced during fitting and removal of the tires on/from the rims.

Furthermore, in the case of anchoring the carcass reinforcement around a bead wire, which consists in at least partly winding the carcass reinforcement around a bead wire in each of the beads forming an upturn that extends higher or lower into the sidewall, the layers of reinforcing elements or stiffener also make it possible to prevent or delay the unwinding of the carcass reinforcement during accidental and excessive heating of the rim.

These layers of reinforcing elements or stiffeners are usually positioned axially on the outside of the upturn of the carcass reinforcement and extend to a height in the sidewall greater than that of the upturn in particular to cover the free ends of the reinforcing elements of said upturn.

Although tires are not provided for these cases, it is known that in certain countries tires are used outside of the normal conditions in particular in terms of loads carried and inflation pressure. The presence of layers of reinforcing elements or stiffeners also makes it possible to improve the resistance of the tires to such stresses. Indeed, it appears that the stiffener will protect the carcass reinforcement in the bead region of the tire against these stresses corresponding to excessive usages. This protection does not however occur without risk of damaging said stiffener; observed in particular during such usages are breaks of the reinforcing elements of the stiffener in the regions put under compression and/or damage, via cracking, of the polymer blends surrounding the radially outer end of the stiffener.

In order to prevent greater degradations of the bead region and in particular crack propagation in the direction of the upturn of the carcass reinforcement, it is customary to shift the ends of the upturn of the carcass reinforcement and of the stiffener in the radial direction, the shift being large enough to prevent these propagations.

It is furthermore customary to cover the radially outer end of the stiffener with a layer of polymer blend, which is described as an edging polymer blend, having a modulus equal to that of the calendering of the stiffener and advantageously of the same nature as the latter. Such edging contributes to the good cohesion, after vulcanization, of the various constituents of the tire in this region close to the radially outer end of the stiffener.

It is also known to insert a layer of polymer blend between at least the end of the carcass reinforcement upturn and the optionally edged stiffener, the modulus of elasticity of which is relatively low, less than the modulus of the calendering of the stiffener, and customarily less than 4 MPa. A modulus gradient thus appears through the various polymer blends separating the end of the carcass reinforcement upturn and the stiffener. This gradient delays the initiation of cracks at the end of the stiffener and limits their propagation, in particular in the direction of the end of the upturn of the carcass reinforcement. This gradient may for example make it possible to limit the shift between the ends of the upturn of the carcass reinforcement and of the stiffener in the radial direction. The sum of the thicknesses of blends at the end of the carcass reinforcement upturn is customarily greater than 3.5 mm and usually of the order of 4.5 mm. The sum of the thicknesses encompasses the thickness of the calenderings of the stiffener and of the carcass reinforcement upturn, the thickness of the layer of polymer blend in contact with the carcass reinforcement upturn and the modulus of elasticity of which is customarily less than 4 MPa and the thickness of the edging layer, if it is present and is inserted between the stiffener and a portion of the carcass reinforcement upturn.

The excessive stresses in terms of loads carried and inflation pressure accentuate the risk of an unwinding of the carcass reinforcement. One solution would then be to produce an upturn of the carcass reinforcement, the end of which is radially further away from the bead wire, but it emerges from what has just been presented that, at the same time, the radially outer end of the stiffener which would be radially even further away from the bead wire would be subjected to more stresses during the running of the tire, increasing the risks of cracking within the surrounding polymer blends.

### SUMMARY

The inventors thus set themselves the mission of providing tires for heavy vehicles of the heavy-goods vehicle type, the endurance performances of which are improved during, in particular, excessive usage in terms of loads carried and inflation pressure which may lead in particular to an unwinding of the carcass reinforcement.

This objective has been achieved according to the invention by a tire having a radial carcass reinforcement, consisting of at least one layer of reinforcing elements, said tire comprising a crown reinforcement, which is itself covered radially with a tread, said tread being joined to two beads via two sidewalls, at least one layer of reinforcing elements of the carcass reinforcement being anchored in each of the beads by an upturn around a bead wire, said carcass reinforcement upturn being reinforced by at least one layer of reinforcing elements or stiffener, the reinforcing elements of at least one stiffener being non-wrapped metal cords with saturated layers, having, in what is called the permeability test, a flow rate of less than 5 cm³/min and the thickness of the polymer blends separating the stiffener from the end of the carcass reinforcement upturn being strictly less than 3.5 mm and preferably less than or equal to 3 mm.

Within the meaning of the invention, a saturated layer of a layered cord is a layer consisting of threads in which there is not enough space to add thereto at least one additional thread.

The thickness of the polymer blends separating the stiffener from the end of the carcass reinforcement upturn is measured between the end of the carcass reinforcement upturn and the orthogonal projection of said end onto the stiffener. More specifically, it is measured from cord to cord, i.e. between a cord of the carcass reinforcement upturn and a cord of the stiffener. In other words, this thickness encompasses the respective thicknesses of the rubbery calendering blends of the stiffener and of the carcass reinforcement upturn, the thickness of a polymer blend optionally present for separating the end of the carcass reinforcement upturn from the stiffener and also the thickness of an edging layer of the radially outer end of the stiffener if it is present and inserted between the stiffener and the carcass reinforcement upturn.

According to a preferred embodiment of the invention, the radially outer end of the stiffener is radially on the outside of the end of the upturn.

According to a first variant of the invention, at least the end of the carcass reinforcement upturn is separated from the stiffener by at least one layer of polymer blend. This first variant of the invention reproduces a customary configuration with a reduced thickness of said at least one layer of polymer blend. It is possible to find, as explained above, a combination of an edging layer of the stiffener which is inserted between the stiffener and the carcass reinforcement upturn and a layer of polymer blend in contact with the carcass reinforcement upturn and the modulus of elasticity of which makes it possible to create a modulus gradient.

According to a second variant of the invention, the calendering layers of the stiffener and of the upturn of the carcass reinforcement are in contact with one another. According to this second variant of the invention, no layer of polymer blend is present for separating the end of the carcass reinforcement upturn from the stiffener. According to this second variant of the invention, an edging layer covering the radially outer end of the stiffener may be present but is not inserted between the stiffener and the carcass reinforcement upturn.

According to a third variant of the invention, at least the end of the carcass reinforcement upturn is separated from the stiffener by an edging layer covering the radially outer end of the stiffener.

The circumferential direction of the tire, or longitudinal direction, is the direction corresponding to the periphery of the tire and defined by the running direction of the tire.

The transverse or axial direction of the tire is parallel to the axis of rotation of the tire.

The radial direction is a direction cutting the axis of rotation of the tire and perpendicular thereto.

The axis of rotation of the tire is the axis about which it rotates in normal use.

A radial or meridian plane is a plane that contains the axis of rotation of the tire.

The circumferential median plane, or equatorial plane, is a plane perpendicular to the axis of rotation of the tire and that divides the tire into two halves.

What is called the permeability test is used to determine longitudinal permeability to air of the tested cords, by measuring the volume of air passing through a test specimen under constant pressure for a given time. The principle of such a test, well known to those skilled in the art, is to demonstrate the effectiveness of the treatment of a cord for making it impermeable to air. The test has been described for example in the standard ASTM D2692-98.

The test is carried out on cords directly extracted, by stripping, from the vulcanized rubber plies that they reinforce, and therefore on cords that have been penetrated by cured rubber. In the case of wrapped cords, the test is carried out after having removed the twisted or untwisted yarn used as wrapping strand.

The test is carried out on a 2 cm length of cord, and therefore cord coated with its surrounding rubber composition (or coating rubber) in the cured state, in the following manner: air is sent into the cord, under a pressure of 1 bar, and the volume of air leaving it is measured using a flowmeter (calibrated for example from 0 to 500 cm³/min). During the measurement, the cord specimen is blocked in a compressed seal (for example a seal made of dense foam or rubber) in such a way that only the amount of air passing through the cord from one end to the other, along its longitudinal axis, is taken into account in the measurement. The sealing provided by the seal itself is checked beforehand using a solid rubber test specimen, that is to say one without a cord.

The measured average air flow rate (average over 10 test specimens) is lower the higher the longitudinal impermeability of the cord. Since the measurement is made with an accuracy of ±0.2 cm³/min, the measured values equal to or less than 0.2 cm³/min are considered to be zero and correspond to a cord that may be termed airtight (completely airtight) along its axis (i.e. in its longitudinal direction).

This permeability test also constitutes a simple means of indirectly measuring the degree of penetration of the cord by a rubber composition. The measured flow rate is lower the higher the degree of penetration of the cord by the rubber.

Cords having in what is called the permeability test a flow rate of less than 20 cm³/min have a degree of penetration greater than 66%.

Cords having in what is called the permeability test a flow rate of less than 2 cm³/min have a degree of penetration greater than 90%.

The degree of penetration of a cord may also be estimated using the method described below. In the case of a layered cord, the method consists firstly in removing the outer layer on a specimen having a length between 2 and 4 cm and then measuring, along a longitudinal direction and along a given axis, the sum of the lengths of rubber compound in relation to the length of the specimen. These rubber compound length measurements exclude the spaces not penetrated along this longitudinal axis. These measurements are repeated along three longitudinal axes distributed over the periphery of the specimen and repeated on five cord specimens.

When the cord comprises several layers, the first, removal step is repeated with the newly external layer and the rubber compound lengths measured along longitudinal axes.

All the ratios of rubber compound lengths to specimen lengths thus determined are then averaged so as to define the degree of penetration of the cord.

The inventors have demonstrated that a tire produced in this way according to the invention leads to very advantageous improvements in terms of endurance in particular when the latter is subjected to excessive stresses. Indeed, the tests carried out with excessive loads carried, the tire being inflated to a pressure above the recommended pressure, have shown that this tire did not exhibit overly pronounced damage in the region of the beads and that no unwinding of the carcass reinforcement is observed when the tire is running. A tire of more standard design used under the same conditions shows either much more pronounced damage, cracks that propagate up to the carcass reinforcement upturn, or an unwinding of the carcass reinforcement when the tire is running, in particular in situations of intensive and prolonged braking.

The inventors interpret these results by the presence of a stiffener consisting of non-wrapped cords with saturated layers, having in what is called the permeability test a flow rate of less than 5 cm³/min, which makes it possible to limit the risks of cracks appearing in the polymer blends at the ends of the stiffener. The smaller thickness of the polymer blends in the case of tires of more standard design, between the stiffener and the end of the upturn of the carcass reinforcement is thus not detrimental even though such a reduced thickness is more favorable to crack propagation; a smaller thickness in the case of tires of more standard design also seems to make it possible to improve the behavior of said upturn in particular as regards the risks of unwinding of the carcass reinforcement in the event of intensive and prolonged braking, more particularly in the event of an overload on the tire. Indeed, it is thus possible to improve the behavior of the carcass reinforcement and to prevent the unwinding thereof without adversely affecting the radially outer ends of the stiffener and of the upturn of the carcass reinforcement due to a design that is more favorable to crack propagation.

A reduced appearance of cracking phenomena at the radially inner end of the stiffener, no doubt linked to the presence of cords of the stiffener having in what is called the permeability test a flow rate of less than 5 cm³/min also seems to contribute to combating the unwinding of the carcass reinforcement.

The cords of the stiffener according to the invention thus result in an improvement in the endurance of the stiffener. Specifically, the reinforcing elements of the stiffener are in particular subjected to flexural and compressive stresses during running which adversely affect their endurance. The cords that make up the reinforcing elements of the stiffeners are in fact subjected to large stresses when the tires are running, especially to repeated flexural stresses or variations in curvature, leading to friction between the threads, and therefore wear and fatigue: this phenomenon is termed “fretting fatigue”.

To fulfil their function of strengthening the stiffener, said cords must firstly have good flexibility and a high endurance in flexure, which means in particular that their threads have a relatively small diameter, preferably less than 0.28 mm, more preferably less than 0.25 mm, generally smaller than that of the threads used in conventional cords for the crown reinforcements of tires, for example.

The cords of the stiffener are also subject to the phenomena of “fatigue-corrosion” due to the very nature of the cords, which promote the passage of corrosive agents such as oxygen and moisture or even drain said agents. Specifically, air or water penetrating the tire, for example as a result of degradation following a cut or more simply because of the permeability, albeit low, of the inner surface of the tire, may be conveyed by the channels formed within the cords because of their very structure.

All these fatigue phenomena, which are generally grouped together under the generic term “fretting-fatigue-corrosion”, are the cause of progressive degradation of the mechanical properties of the cords and may, under the severest running conditions, affect the lifetime of said cords.

The cords according to the invention will therefore enable the stiffeners to better withstand these “fretting-fatigue-corrosion” phenomena.

More preferably according to the invention, the cords of at least one stiffener have in what is called the permeability test a flow rate of less than 2 cm³/min.

According to one advantageous embodiment of the invention, said metal reinforcing elements, having in what is called the permeability test a flow rate of less than 5 cm³/min, of at least one stiffener are cords having at least two layers, at least one inner layer being sheathed with a layer consisting of a polymer composition such as a crosslinkable or crosslinked rubber composition, preferably based on at least one diene elastomer.

According to a preferred embodiment of the invention, the reinforcing elements of at least one layer of the carcass reinforcement are metal cords having, in what is called the permeability test, a flow rate of less than 20 cm³/min.

The cords of the carcass reinforcement that are subjected in the same way to the “fretting-fatigue-corrosion” phenomena may thus also have a better resistance to these wear and fatigue phenomena and therefore help to improve the endurance of the tire in particular used under extreme conditions.

In the case of a carcass reinforcement comprising several layers of reinforcing elements, each of said layers may be in accordance with the invention. Advantageously at least the radially outer layer comprises metal cords having, in what is called the permeability test, a flow rate of less than 20 cm³/min.

More preferably according to the invention, the cords of at least one layer of the carcass reinforcement have, in what is called the permeability test, a flow rate of less than 10 cm³/min and more preferably less than 2 cm³/min.

According to one advantageous embodiment of the invention, said metal reinforcing elements, having in what is called the permeability test a flow rate of less than 20 cm³/min, of at least one layer of the carcass reinforcement are cords having at least two layers, at least one inner layer being sheathed with a layer consisting of a polymer composition such as a crosslinkable or crosslinked rubber composition, preferably based on at least one diene elastomer.

The invention also provides a tire having a radial carcass reinforcement consisting of at least one layer of reinforcing elements, said tire comprising a crown reinforcement, which is itself covered radially with a tread, said tread being joined to two beads via two sidewalls, at least one layer of reinforcing elements of the carcass reinforcement being anchored in each of the beads by an upturn around a bead wire, said carcass reinforcement upturn being reinforced by at least one layer of reinforcing elements or stiffener, at least the end of the carcass reinforcement upturn being separated from the stiffener by a layer of polymer blend, the reinforcing elements of at least one stiffener being non-wrapped metal cords having at least two saturated layers, at least one inner layer being sheathed with a layer consisting of a polymer composition such as a crosslinkable or crosslinked rubber composition, preferably based on at least one diene elastomer and the thickness of the polymer blends separating the stiffener from the end of the carcass reinforcement upturn being strictly less than 3.5 mm and preferably less than or equal to 3 mm.

According to a preferred embodiment of the invention, the radially outer end of the stiffener is radially on the outside of the end of the upturn.

According to one advantageous embodiment of the invention, the reinforcing elements of at least one layer of the carcass reinforcement are then metal cords having at least two layers, at least one inner layer being sheathed with a layer consisting of a polymer composition such as a crosslinkable or crosslinked rubber composition, preferably based on at least one diene elastomer.

Within the meaning of the invention, non-wrapped metal cords having at least two saturated layers, at least one inner layer being sheathed with a layer consisting of a polymer composition such as a crosslinkable or crosslinked rubber composition, have in what is called the permeability test a flow rate of almost zero and therefore of less than 5 cm³/min.

The expression “composition based on at least one diene elastomer” is understood to mean, as is known, that the composition comprises predominantly (i.e. with a mass fraction greater than 50%) this or these diene elastomers.

It should be noted that the sheath according to the invention extends continuously around the layer that it covers (that is to say this sheath is continuous in the “orthoradial” direction of the cord, which is perpendicular to its radius) so as to form a continuous sleeve having a cross section that is advantageously almost circular.

It should also be noted that the rubber composition of this sheath is crosslinkable or crosslinked, that is to say it includes, by definition, a suitable crosslinking system thus allowing the composition to crosslink while it undergoes curing (i.e. it cures and does not melt). Thus, this rubber composition may be termed “non-melting”, because it cannot be melted by heating it to any temperature.

The term “diene” elastomer or rubber is understood, as is known, to mean an elastomer resulting at least partly (i.e. a homopolymer or a copolymer) from diene monomers (monomers bearing two carbon-carbon double bonds, whether conjugated or not).

Diene elastomers can be classified, in a known manner, into two categories: those referred to as “essentially unsaturated” diene elastomers and those referred to as “essentially saturated” diene elastomers. In general, an “essentially unsaturated” diene elastomer is understood here to mean a diene elastomer resulting at least partly from conjugated diene monomers having a content of units of diene origin (conjugated dienes) that is greater than 15% (mol %). Thus, for example, diene elastomers such as butyl rubbers or copolymers of dienes and cc-olefins of the EPDM type do not fall within the above definition and in particular can be termed “essentially saturated” diene elastomers (having a low or very low content of units of diene origin, always less than 15%). In the category of “essentially unsaturated” diene elastomers, the expression “highly unsaturated” diene elastomer is understood in particular to mean a diene elastomer having a content of units of diene origin (conjugated dienes) that is greater than 50%.

Having given these definitions, it will be understood more particularly that a diene elastomer capable of being used in the cord of the invention means:
(a) any homopolymer obtained by polymerization of a conjugated diene monomer having from 4 to 12 carbon atoms;
(b) any copolymer obtained by copolymerization of one or more conjugated dienes with one another or with one or more vinylaromatic compounds having from 8 to 20 carbon atoms;
(c) a ternary copolymer obtained by copolymerization of ethylene and of an α-olefin having from 3 to 6 carbon atoms with an unconjugated diene monomer having from 6 to 12 carbon atoms, such as, for example, the elastomers obtained from ethylene and propylene with an unconjugated diene monomer of the abovementioned type, such as, in particular, 1,4-hexadiene, ethylidene norbornene or dicyclopentadiene;
(d) a copolymer of isobutene and of isoprene (butyl rubber) and also the halogenated versions, in particular chlorinated or brominated versions, of this type of copolymer.

Although it applies to any type of diene elastomer, the present invention is firstly used with essentially unsaturated diene elastomers, in particular of the type (a) or (b) above.

Thus, the diene elastomer is preferably selected from the group consisting of polybutadienes (BR), natural rubber (NR), synthetic polyisoprenes (IR), various butadiene copolymers, various isoprene copolymers and blends of these elastomers. More preferably, such copolymers are selected from the group consisting of stirene-butadiene copolymers (SBR), butadiene-isoprene copolymers (BIR), stirene-isoprene copolymers (SIR) and stirene-butadiene-isoprene copolymers (SBIR).

More preferably according to the invention, the diene elastomer selected predominantly (i.e. in respect of more than 50 phr) consists of an isoprene elastomer. The term “isoprene elastomer” is understood to mean, as is known, an isoprene homopolymer or copolymer, in other words a diene elastomer selected from the group consisting of natural rubber (NR), synthetic polyisoprenes (IR), various isoprene copolymers and blends of these elastomers.

According to one advantageous embodiment of the invention, the diene elastomer selected consists exclusively (i.e. for 100 phr) of natural rubber, synthetic polyisoprene or a blend of these elastomers, the synthetic polyisoprene having a content (in mol %) of cis-1,4-bonds preferably greater than 90%, and even more preferably greater than 98%.

It would also be possible to use, according to one particular embodiment of the invention, cuts (blends) of this natural rubber and/or these synthetic polyisoprenes with other highly unsaturated diene elastomers, especially with SBR or BR elastomers as mentioned above.

The rubber sheath of the cord of the invention may contain one or more diene elastomers, it being possible for these to be used in combination with any type of synthetic elastomer other than those of diene type, or even with polymers other than elastomers, for example thermoplastic polymers, these polymers other than elastomers then being present by way of minority polymer.

Although the rubber composition of said sheath is preferably devoid of any plastomer and contains only a diene elastomer (or blend of diene elastomers) as polymeric base, said composition could also include at least one plastomer with a mass fraction xₚ which is less than the mass fraction xₑ of the elastomer(s). In such a case, the following relationship preferably applies: 0<xₚ<0.5xₑ and more preferably the following relationship applies: 0<xₚ<0.1xₑ.

Preferably, the crosslinking system of the rubber sheath is a system referred to as a vulcanization system, that is to say one based on sulphur (or on a sulphur donor) and a primary vulcanization accelerator. Added to this base vulcanization system may be various known secondary vulcanization accelerators or vulcanization activators. Sulphur is used with a preferential amount of between 0.5 and 10 phr, more preferably between 1 and 8 phr, and the primary vulcanization accelerator, for example a sulphenamide, is used with a preferential amount of between 0.5 and 10 phr, more preferably between 0.5 and 5.0 phr.

The rubber composition of the sheath according to the invention includes, besides said crosslinking system, all the common ingredients that can be used in rubber compositions for tires, such as reinforcing fillers based on carbon black and/or an inorganic reinforcing filler such as silica, anti-ageing agents, for example antioxidants, extender oils, plasticizers or processing aids, which make it easier to process the compositions in the uncured state, methylene donors and acceptors, resins, bismaleimides, known adhesion promoter systems of the RFS (resorcinol-formaldehyde-silica) type or metal salts, especially cobalt salts.

Preferably, the composition of the rubber sheath has, in the crosslinked state, a secant modulus in extension at 10% elongation (denoted by M10), measured according to the ASTM D 412 standard of 1998, of less than 20 MPa and more preferably less than 12 MPa, in particular between 4 and 11 MPa.

Preferably, the composition of this sheath is chosen to be the same as the composition used for the rubber matrix that the cords according to the invention are intended to reinforce. Thus, there is no problem of any incompatibility between the respective materials of the sheath and the rubber matrix.

Preferably, said composition is based on natural rubber and contains carbon black as reinforcing filler, for example carbon black of 300, 600 or 700 (ASTM) grade (for example N326, N330, N347, N375, N683 or N772).

According to a variant of the invention, the reinforcing elements of at least one stiffener, having in what is called the permeability test a flow rate of less than 5 cm³/min, and also advantageously the reinforcing elements of at least one layer of the carcass reinforcement, having in what is called the permeability test a flow rate of less than 20 cm³/min, are layered metal cords of [L+M] or [L+M+N] construction, comprising a first layer C1 having L threads of diameter d₁ where L ranges from 1 to 4, surrounded by at least one intermediate layer C2 having M threads of diameter d₂ wound together in a helix with a pitch p₂ where M ranges from 3 to 12, said layer C2 being optionally surrounded by an outer layer C3 of N threads of diameter d₃ wound together in a helix with a pitch p₃, where N ranges from 8 to 20, a sheath consisting of a crosslinkable or crosslinked rubber composition based on at least one diene elastomer covering, in the [L+M] construction, said first layer C1 and, in the [L+M+N] construction, at least said layer C2.

Preferably, the diameter of the threads of the first layer of the inner layer (C1) is between 0.10 and 0.5 mm and the diameter of the threads of the outer layers (C2, C3) is between 0.10 and 0.5 mm.

More preferably, the helix pitch with which said threads of the outer layer (C3) are wound is between 8 and 25 mm.

Within the meaning of the invention, the pitch represents the length, measured parallel to the axis of the cord, at the end of which a thread having this pitch makes one complete turn around the axis of the cord; thus, if the axis is sectioned by two planes perpendicular to said axis and separated by a length equal to the pitch of a thread of a constituent layer of the cord, the axis of this thread in these two planes has the same position on the two circles corresponding to the layer of the thread in question.

Advantageously, the cord has one, and more preferably still all of the following characteristics, which is/are confirmed:
the layer C3 is a saturated layer, that is to say there exists insufficient space in this layer to add to it at least an (N+1)th thread of diameter d₃, N then representing the maximum number of threads that can be wound as a layer around the layer C2;
the rubber sheath furthermore covers the inner layer C1 and/or separates the pairwise adjacent threads of the intermediate layer C2;
the rubber sheath covers practically the radially internal semi-circumference of each thread of the layer C3 in such a way that it separates the pairwise adjacent threads of this layer C3.

In the L+M+N construction according to the invention, the intermediate layer C2 preferably comprises six or seven threads and the cord according to the invention then has the following preferential characteristics (d₁, d₂, d₃, p₂ and p₃ in mm):
(i) 0.10<d₁<0.28;
(ii) 0.10<d₂<0.25;
(iii) 0.10<d₃<0.25;
(iv) M=6 or M=7;
(v) 5π(d₁+d₂)<p₂≦p₃<5π(d₁+2d₂+d₃);
(vi) the threads of said layers C2, C3 are wound in the same twist direction (S/S or Z/Z).

Preferably, characteristic (v) is such that p₂=p₃, in such a way that the cord is said to be “compact” considering moreover characteristic (vi) (threads of the layers C2 and C3 wound in the same direction).

According to characteristic (vi), all the threads of the layers C2 and C3 are wound in the same twist direction, that is to say either in the direction S (“S/S” arrangement) or in the direction Z (“Z/Z” arrangement). By winding the layers C2 and C3 in the same direction, it is advantageously possible in the cord according to the invention to minimize the friction between these two layers C2 and C3 and therefore the wear of the threads constituting them (since there is no longer crossed contact between the threads).

Preferably, said metal cords of at least one stiffener, having in what is called the permeability test a flow rate of less than 5 cm³/min, and also advantageously said metal cords of at least one layer of the carcass reinforcement, having in what is called the permeability test a flow rate of less than 20 cm³/min, are layered cords of L+M+N construction, that is to say that the inner layer C1 consists of a single thread.

Again advantageously, the (d₁/d₂) ratios are preferably set within given limits, according to the number M (6 or 7) of threads in the layer C2, as follows:
for M=6: 0.9<(d₁/d₂)<1.3;
for M=7: 1.3<(d₁/d₂)<1.6.

Too low a value of the ratio d₁/d₂ may be prejudicial to wear between the inner layer and the threads of the layer C2. As for too high a value, this may impair the compactness of the cord, for a barely modified definitive level of strength, and may also impair its flexibility. The greater rigidity of the inner layer C1 due to too high a diameter d₁ could moreover be prejudicial to the very feasibility of the cord during the cabling operations.

The threads of the layers C2 and C3 may have the same diameter or this may differ from one layer to the other. Preferably, threads of the same diameter (d₂=d₃) are used, especially to simplify the cabling process and to lower the costs.

The maximum number Nₘₐₓ of threads that can be wound as a single saturated layer C3 around the layer C2 depends of course on many parameters (diameter d₁ of the inner layer, number M and diameter d₂ of the threads of the layer C2, and diameter d₃ of the threads of the layer C3).

Said metal cords of at least one stiffener, having in what is called the permeability test a flow rate of less than 5 cm³/min, and also advantageously said metal cords of at least one layer of the carcass reinforcement, having in what is called the permeability test a flow rate of less than 20 cm³/min, are preferably selected from cords of 1+6+10, 1+6+11, 1+6+12, 1+7+11, 1+7+12 or 1+7+13 construction.

For a better compromise between strength, feasibility and flexural strength of the cord, on the one hand, and penetrability by the rubber on the other hand, it is preferred for the diameters of the threads of the layers C2 and C3, whether identical or not, to be less than 0.22 mm and preferably greater than 0.12 mm.

In such a case, it is preferred to have the following relationships, which are confirmed:
0.14<d₁<0.22;
0.12<d₂≦d₃<0.20;
5<p₂≦p₃<12 (small pitches in mm) or else 20<p₂≦p₃<30 (large pitches in mm).

A diameter less than 0.19 mm helps reduce the level of stresses undergone by the threads during the large variations in curvature of the cords, while it is preferred to choose diameters greater than 0.16 mm in particular for thread strength and industrial cost reasons.

One advantageous embodiment consists for example in choosing p₂ and p₃ to be between 8 and 12 mm, advantageously with cords of 1+6+12 construction.

Preferably, the rubber sheath has an average thickness ranging from 0.010 mm to 0.040 mm.

In general, said metal cords of at least one stiffener, having in what is called the permeability test a flow rate of less than 5 cm³/min, and also advantageously said metal cords of at least one layer of the carcass reinforcement, having in what is called the permeability test a flow rate of less than 20 cm³/min, according to the invention may be produced with any type of metal threads, especially steel threads, for example carbon steel threads and/or stainless steel threads. It is preferred to use a carbon steel but of course it is possible to use other steels or other alloys.

When a carbon steel is used, its carbon content (% by weight of steel) is preferably between 0.1% and 1.2%, more preferably from 0.4% to 1.0%. These contents represent a good compromise between the required mechanical properties of the tire and the feasibility of the thread. It should be noted that a carbon content of between 0.5% and 0.6% finally makes such steels less expensive, as they are easier to draw. Another advantageous embodiment of the invention may also consist, depending on the intended applications, in using low carbon steels, for example having a carbon content of between 0.2% and 0.5%, especially because they have a lower cost and drawing is much easier.

Said metal cords of at least one stiffener and also advantageously of at least one layer of the carcass reinforcement according to the invention may be obtained by various techniques known to those skilled in the art, for example, in two steps: firstly a step in which the L+M intermediate structure or core (layers C1+C2) is sheathed via an extrusion head and secondly this step is followed by a final operation in which the N remaining threads (layer C3) are cabled or twisted around the thus sheathed layer C2. The problem of bonding in the uncured state posed by the rubber sheath, during possible intermediate winding and unwinding operations, may be solved in a manner known to those skilled in the art, for example by using an intermediate plastic film.

According to a first embodiment variant of the invention, when at least one layer of polymer blend is present for separating the stiffener from the end of the carcass reinforcement upturn, the modulus of elasticity of the layer of blend in contact with the carcass reinforcement upturn is greater than 4 MPa. The presence of a layer of polymer blend, having a higher modulus of elasticity in the case of a tire of more standard design, between the stiffener and the end of the upturn of the carcass reinforcement has turned out not to be detrimental even though said layer of polymer blend is more favorable to crack propagation; in addition, such a polymer blend having a higher modulus of elasticity in the case of tires of more standard design seems to make it possible to help to improve the behavior of said upturn in particular as regards the risks of unwinding of the carcass reinforcement in the event of intensive and prolonged braking, more particularly in the event of an overload on the tire.

According to a second embodiment variant of the invention, the modulus of elasticity of the layer of polymer blend separating the stiffener from the end of the carcass reinforcement upturn and in contact with said carcass reinforcement upturn is strictly less than 4 MPa.

According to a preferred embodiment of the invention, since the upturn of the carcass reinforcement is separated from the carcass reinforcement by a polymer blend positioned radially on the outside of the bead wire, said polymer blend has a modulus of elasticity of greater than 4 MPa. Such a value of the modulus of elasticity of this polymer blend separating the upturn of the carcass reinforcement from the reinforcement itself also contributes to a better unwinding resistance of the tire.

More preferably, the polymer blend separating the upturn of the carcass reinforcement from the carcass reinforcement has the same modulus of elasticity as that of the layer of polymer blend in contact with the carcass reinforcement upturn and separating at least the end of the carcass reinforcement upturn from the stiffener when this layer is present. Advantageously the two polymer blends are identical in terms of composition.

One advantageous embodiment of the invention envisages that the modulus of elasticity of the polymer blends of the calendering layers of the carcass reinforcement is less than or equal to 8 MPa. Such polymer blends may be used in combination with the characteristics of the stiffener according to the invention without being detrimental to the risk of unwinding of the carcass reinforcement. It is indeed customary to use polymer blends that have higher moduli in order to improve the resistance to unwinding of the carcass reinforcement; such moduli are usually of the order of 12 MPa. The utilization of blends for which the moduli of elasticity are less than or equal to 8 MPa will make it possible to improve the properties of the tire as regards rolling resistance. More precisely, a lower modulus of elasticity is generally accompanied by a lower viscous modulus G″, this change proving favorable to a reduction in the rolling resistance of the tire.

According to one embodiment variant of the invention, the modulus of elasticity of the polymer blends of the calendering layers of the carcass reinforcement is identical to the moduli of elasticity of the polymer blend separating the upturn of the carcass reinforcement from the carcass reinforcement and of the layer of polymer blend in contact with the carcass reinforcement upturn and separating at least the end of the carcass reinforcement upturn from the stiffener when this layer is present.

The moduli of elasticity are the secant moduli in extension at 10% elongation (denoted by M10), measured according to the ASTM D 412 standard of 1998.

According to one embodiment variant of the invention, the crown reinforcement of the tire is formed from at least two working crown layers of inextensible reinforcing elements, which are crossed from one layer to the other making angles of between 10° and 45° with the circumferential direction.

According to other embodiment variants of the invention, the crown reinforcement also includes at least one layer of circumferential reinforcing elements.

A preferred embodiment of the invention also provides for the crown reinforcement to be supplemented, radially on the outside, by at least one supplementary layer, referred to as protective layer consisting of what are known as elastic reinforcing elements oriented with respect to the circumferential direction at an angle of between 10°and 45° and in the same direction as the angle made by the inextensible elements of the working layer that is radially adjacent thereto.

The protective layer may have an axial width smaller than the axial width of the narrowest working layer. Said protective layer may also have an axial width greater than the axial width of the narrowest working layer, such that it covers the edges of the narrowest working layer and, in the case of the radially upper layer as being the narrowest, such that it is coupled, in the axial extension of the additional reinforcement, to the widest working crown layer over an axial width so as thereafter, axially on the outside, to be decoupled from said widest working layer by profiled elements having a thickness at least equal to 2 mm. The protective layer formed from elastic reinforcing elements may, in the abovementioned case, on the one hand, be optionally decoupled from the edges of said narrowest working layer by profiled elements having a thickness substantially less than the thickness of the profiled elements separating the edges of the two working layers and, on the other hand, have an axial width smaller or larger than the axial width of the widest crown layer.

According to any one of the embodiments of the invention mentioned above, the crown reinforcement may also be supplemented, radially on the inside between the carcass reinforcement and the radially internal working layer closest to said carcass reinforcement, with a triangulation layer of inextensible metal reinforcing elements made of steel making, with the circumferential direction, an angle of greater than 60° and in the same direction as that of the angle made by the reinforcing elements of the radially closest layer of the carcass reinforcement.

### BRIEF DESCRIPTION OF DRAWINGS

Other details and advantageous features of the invention will become apparent below from the description of exemplary embodiments of the invention especially with reference to FIGS. 1 to 5 which show:

FIG. 1, a meridional view of a diagram of a tire according to one embodiment of the invention;

FIG. 2, an enlarged schematic representation of the bead region of the tire from FIG. 1,

FIG. 3, a schematic representation of a cross-sectional view of a first example of metal cord of at least one stiffener of the tire from FIG. 1,

FIG. 4, a schematic representation of a cross-sectional view of a second example of metal cord of at least one stiffener of the tire from FIG. 1,

FIG. 5, a schematic representation of a cross-sectional view of a third example of metal cord of at least one stiffener of the tire from FIG. 1.

The figures have not been drawn to scale so as to make it simpler to understand them.

### DETAILED DESCRIPTION OF SPECIFIC EMBODIMENTS

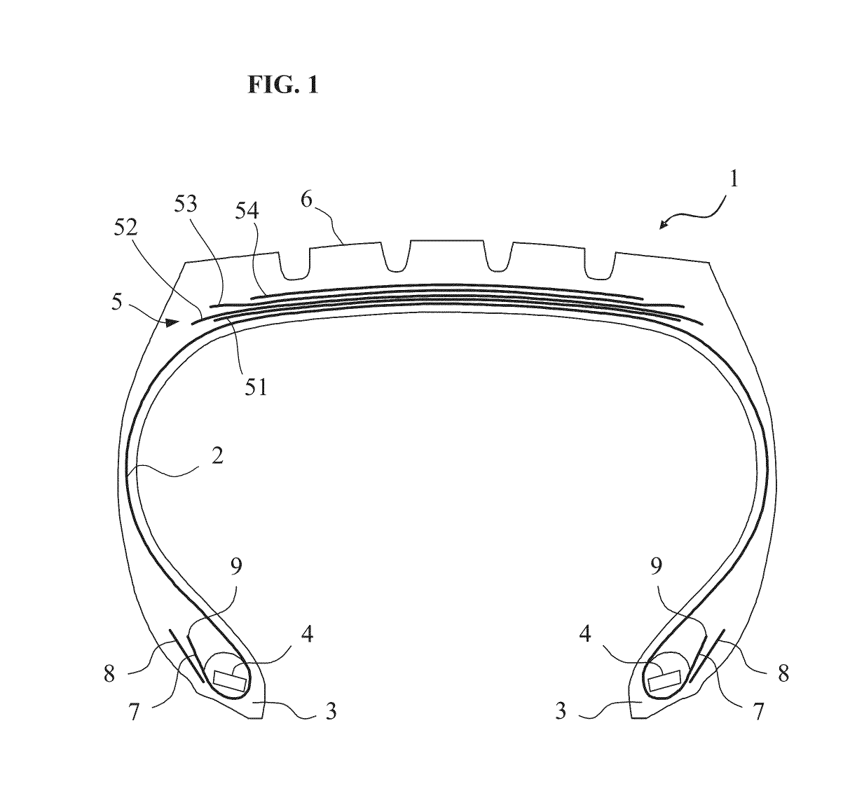

In FIG. 1, the tire 1, of 315/70 R 22.5 dimensions, comprises a radial carcass reinforcement 2 anchored in two beads 3 around bead wires 4. The carcass reinforcement 2 is formed by a single layer of metal cords. The carcass reinforcement 2 is wrapped with a crown reinforcement 5 which is itself covered with a tread 6. The crown reinforcement 5 is formed, radially from the inside to the outside, from:
a triangulation layer 51 formed from continuous non-wrapped inextensible metal cords 2+7×0.28, over the entire width of the ply, said cords being oriented at an angle equal to 65°;
a first working layer 52 formed from continuous non-wrapped inextensible metal cords 0.12+3+8×0.35, over the entire width of the ply, said cords being oriented at an angle equal to 18°;
a second working layer 53 formed from continuous non-wrapped inextensible metal cords 0.12+3+8×0.35, over the entire width of the ply, said cords being oriented at an angle equal to 18° crossed with the metal cords of the first working layer; and
a protective layer 54 formed from elastic metal cords 3×2×0.35.

The layer of carcass reinforcement 2 is wound around a bead wire 4 to form an upturn 7. The upturn 7 is further reinforced by a layer of reinforcing elements or stiffener 8 which covers the end 9 of the upturn 7.

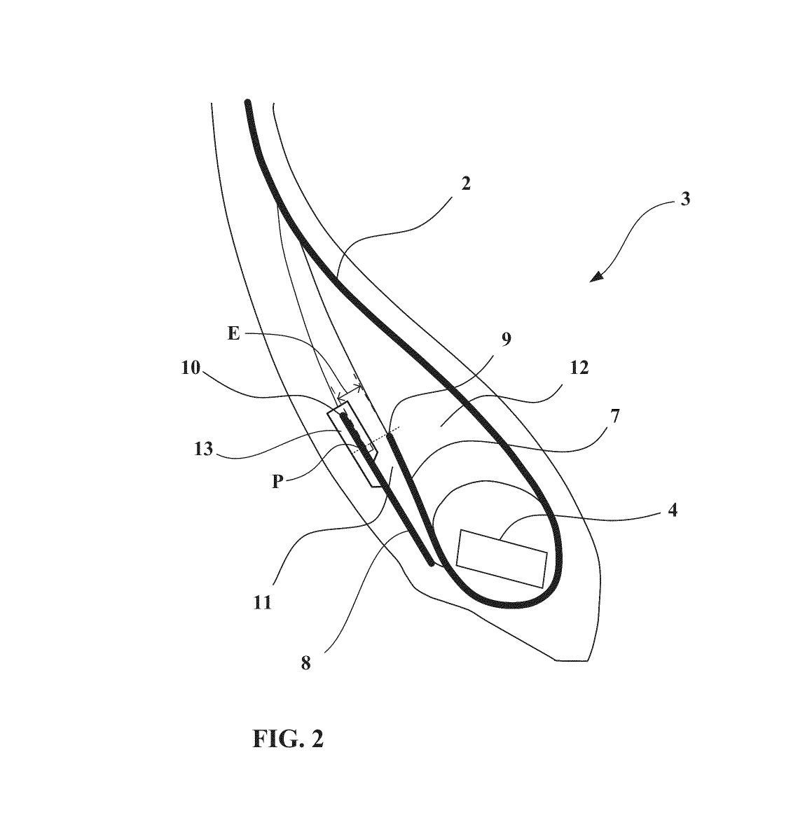

FIG. 2 illustrates, in greater detail, a schematic cross-sectional representation of a bead 3 of the tire in which a portion of the layer of carcass reinforcement 2 is found wound around a bead wire 4 to form an upturn 7, the end 9 of which is covered by the stiffener 8.

The end 10 of the stiffener 8 is thus radially exterior to the end 9 of the upturn 7 of the carcass reinforcement. The radially outer end of the stiffener is covered by an edging layer 13 which is inserted between the stiffener 8 and the carcass reinforcement upturn 7.

The thickness E of the polymer blends between the end 9 of the carcass reinforcement upturn 7 and the point P of the stiffener 8 is equal to 3 mm. In accordance with the invention, such a thickness is less than 3.5 mm.

In the case of the example illustrated in FIG. 2, a layer of polymer blend 11 is in contact with the carcass reinforcement upturn 7 and separates the end 9 of the carcass reinforcement upturn 7 from the stiffener 8.

The thickness E of the polymer blends separating the stiffener from the end of the carcass reinforcement upturn is, in accordance with the invention, measured between the end 9 of the carcass reinforcement upturn 7 and the orthogonal projection P of said end 9 onto the stiffener 8.

This thickness E is composed of the sum of the respective thicknesses of the calenderings of the stiffener and of the carcass reinforcement upturn equal to 0.7 mm, of the thickness of the edging layer 13 equal to 1.2 mm and of that of the layer of polymer blend 11 equal to 1.1 mm.

A polymer blend 12 radially exterior to the bead wire 4 separates the upturn 7 from the carcass reinforcement layer 2.

FIG. 3 illustrates a schematic representation of the cross section of a cord 31 of stiffeners 8 of the tire 1 from FIG. 1. This cord 7a is a non-wrapped layered cord of 1+6+12 construction, consisting of a central core formed by a thread 32, an intermediate layer formed from six threads 33 and an outer layer formed from twelve threads 35.

It has the following characteristics (d and p in mm):
1+6+12 construction;
d₁=0.20 (mm);
d₂=0.18 (mm);
p₂=10 (mm);
d₃=0.18 (mm);
p₃=10 (mm);
(d₂/d₃)=1;
   where d₂ and p₂ are, respectively, the diameter and the helix pitch of the intermediate layer and d₃ and p₃ are, respectively, the diameter and the helix pitch of the threads of the outer layer.

The core of the cord consisting of the central core formed from the thread 32 and from the intermediate layer formed from the six threads 33 is sheathed by a rubber composition 34 based on an unvulcanized diene elastomer (in the uncured state). Sheathing of the core, consisting of the thread 32 surrounded by the six threads 33, carried out by an extrusion head, is followed by a final operation of twisting or cabling the 12 threads 35 around the core thus sheathed.

The cord 31 has in what is called the permeability test, as described above, a flow rate equal to 0 cm³/min and therefore less than 2 cm³/min. Its penetration by the rubber composition is equal to 95%.

The cord 31 has a diameter equal to 0.95 mm.

The elastomer composition constituting the rubber sheath 34 is made from a composition as described above based on natural rubber and carbon black.

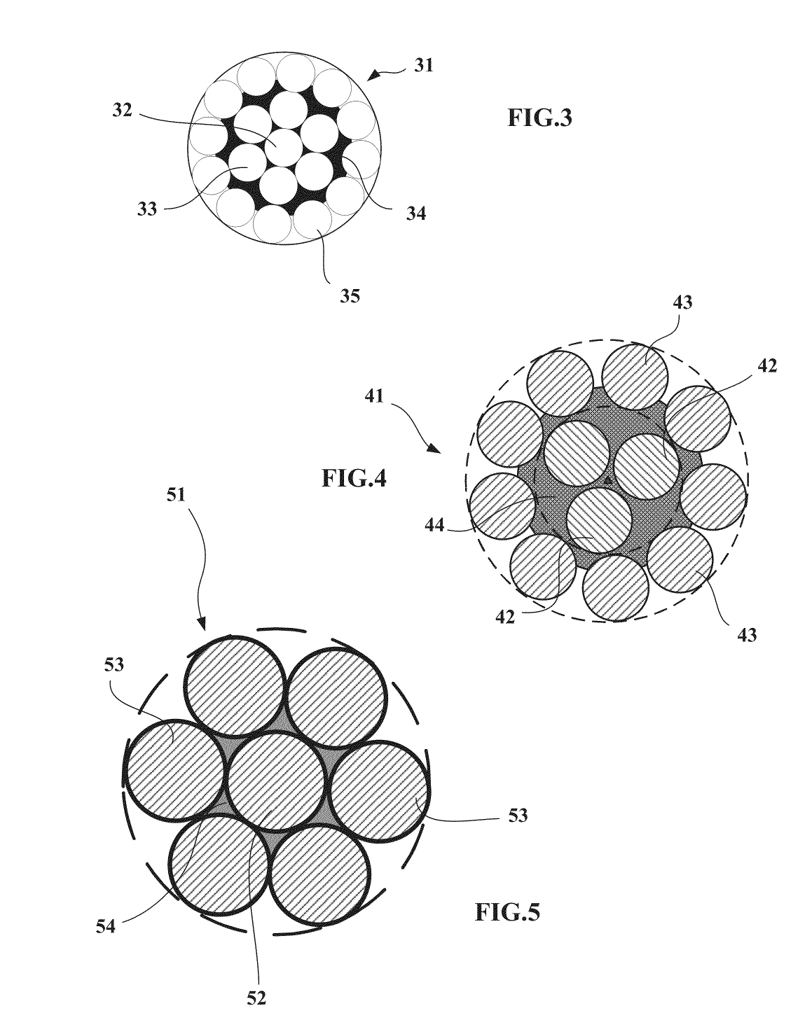

FIG. 4 illustrates a schematic representation of the cross section of another cord 41 of the stiffeners 8 of the tire 1 according to the invention as a replacement for the cord of FIG. 3. This cord 41 is a non-wrapped layered cord of 3+9 construction consisting of a central core formed from a cord consisting of three threads 42 twisted together and an outer layer formed from nine threads 43.

It has the following characteristics (d and p in mm):
3+9 construction;
d₁=0.18 (mm);
p₁=5 (mm)
(d₁/d₂)=1;
d₂=0.18 (mm);
p₂=10 (mm),
   where d₁ and p1 are, respectively, the diameter and the helix pitch of the threads of the central core and d₂ and p₂ are, respectively, the diameter and the helix pitch of the threads of the outer layer.

The central core consisting of a cord formed from the three threads 42 was sheathed with a rubber composition 44 based on an unvulcanized diene elastomer (in the uncured state). The sheathing of the cord 42, carried out by an extrusion head, is followed by a final operation of cabling the nine threads 43 around the core thus sheathed.

The cord 41 has in what is called the permeability test, as described above, a flow rate equal to 0 cm³/min and therefore less than 2 cm³/min. Its penetration by the rubber composition is equal to 95%.

The cord 41 has a diameter equal to 0.8 mm.

FIG. 5 illustrates a schematic representation of the cross section of another cord 51 of the stiffeners 8 of the tire 1 according to the invention as a replacement for the cord of FIG. 3. This cord 51 is a non-wrapped layered cord of 1+6 construction consisting of a central core formed from a thread 52 and an outer layer formed from six threads 53.

It has the following characteristics (d and p in mm):
1+6 construction;
d₁=0.200 (mm);
(d₁/d₂)=1.14;
d₂=0.175 (mm);
p₂=10 (mm),
   where d₁ is the diameter of the core and d₂ and p₂ are, respectively, the diameter and the helix pitch of the threads of the outer layer.

The central core consisting of the thread 52 was sheathed with a rubber composition 54 based on an unvulcanized diene elastomer (in the uncured state). The sheathing of the thread 52, carried out by an extrusion head, is followed by a final operation of cabling the six threads 53 around the core thus sheathed.

The cord 51 has in what is called the permeability test, as described above, a flow rate equal to 0 cm³/min and therefore less than 2 cm³/min. Its penetration by the rubber composition is equal to 95%.

The cord 51 has a diameter equal to 0.6 mm.

The invention such as has just been described, in particular with reference to the exemplary embodiments should not be understood as being limited to these examples. As mentioned previously, the cords of the carcass reinforcement may also be selected from sheathed cords such as those represented in FIGS. 3 to 5. The tires may also comprise a more complex carcass reinforcement, in particular consisting of two layers, it being possible for a single one to form an upturn around a bead wire. The stiffener has been represented with a radially inner end in contact with the upturn of the carcass reinforcement but the stiffener may also be turned up around the bead wire to follow the carcass reinforcement layer over a greater length. The reinforcement of the carcass reinforcement in the bead region may also be obtained by several stiffeners and for example by a combination of one stiffener turned up around the bead wire, the other being parallel to the upturn.

Tests were carried out with tires produced according to the invention as shown in FIGS. 1, 2 and 3, and other tests were carried out on what are referred to as reference tires.

The first reference tires R1 differ from the tires according to the invention by stiffeners identical to those illustrated in FIGS. 1 and 2 and the reinforcing elements of which are cords such as those represented in FIG. 3, but which do not include a sheathing layer.

The second reference tires R2 differ from the tires according to the invention by stiffeners, the reinforcing elements of which are cords such as those represented in FIG. 3, but which do not include a sheathing layer and the thickness of the polymer blends between the stiffener and the end of the carcass reinforcement upturn, measured at the end of the carcass reinforcement upturn is equal to 4.5 mm.

Endurance tests were carried out on a test machine imposing 25% to 35% sag on the tires, for running speeds of from 60 to 20 km/h.

Before performing the tests, the tires undergo an accelerated ageing in an oven under inflation gas oxygen content conditions and temperature conditions that are suitable for producing a state of thermal oxidation of the materials that is representative of average wear during a field service life.

The tests were carried out for the tires according to the invention with conditions identical to those applied to the reference tires.

The tests carried out result, for the tires R2, in performances that establish the base 100. The tests are stopped on appearance of a degradation of the low region of the tire.

Depending on the various conditions imposed, the tires R1 ran shorter distances, in a range of equivalent values, extending from 65 to 75.

The tires according to the invention ran distances at least equivalent to that of the tires R2.

These results show that the combination of a stiffener comprising cords according to the invention with a thickness of polymer blends between the end of the upturn and the stiffener in accordance with the invention makes it possible to obtain a performance, in terms of endurance, of the low region of the tire which is similar to that of a tire of more standard configuration, for which the stiffener comprises unsheathed reinforcing elements and for which the thickness of polymer blends separating the end of the upturn from the stiffener is larger.

Furthermore, unwinding tests of the carcass reinforcement layer were carried out on a test machine imposing on the tires a gradual stepped heating of the rim.

In the same way as above, a value 100 is attributed to the tires R2 while a value of at least 130 is attributed to the tires according to the invention.

Other unwinding tests of the carcass reinforcement layer were then carried out with tires in accordance with the invention, the modulus of the calendering of the carcass reinforcement being equal to 8 MPa, and also with reference tires R2, for which the modulus of the calendering of the carcass reinforcement is equal to 8 MPa. In the preceding tests, the modulus of elasticity of the calendering of the carcass reinforcement was equal to 12 MPa.

The tires R2 with a modulus of elasticity of the calendering of the carcass reinforcement equal to 8 MPa resulted in values very close to 70.

The tires in accordance with the invention, for which the modulus of elasticity of the calendering of the carcass reinforcement is equal to 8 MPa resulted in values very close to 100.

The latter tests show that the design of the tires according to the invention allows a reduction in the modulus of elasticity of the calendering of the carcass reinforcement without generating risks of unwinding of the carcass reinforcement.

Rolling resistance measurements showed that this reduction in the modulus of elasticity of the calendering of the carcass reinforcement results in a gain of the order of 0.1 kg/t.

1. A tire having a radial carcass reinforcement, having at least one layer of reinforcing elements, said tire comprising a crown reinforcement, which is itself covered radially with a tread, said tread being joined to two beads via two sidewalls, at least one layer of reinforcing elements of the radial carcass reinforcement being anchored in each of the beads by an upturn around a bead wire, said radial carcass reinforcement upturn being reinforced by at least one stiffener comprising a layer of reinforcing elements, wherein the reinforcing elements of at least one stiffener are non-wrapped metal cords with saturated layers, having, in what is called the permeability test, a flow rate of less than 5 cm³/min and in the thickness of polymer blends separating the stiffener from the end of the radial carcass reinforcement upturn is strictly less than 3.5 mm.

2. The tire according to claim 1, wherein the non-wrapped metal cords with saturated layers have, in what is called the permeability test, a flow rate of less than 5 cm³/min are cords having at least two layers and wherein at least one inner layer is sheathed with a layer consisting of a polymer composition.

3. The tire according to claim 1, wherein said non-wrapped metal cords with saturated layers of at least one stiffener have, in what is called the permeability test, a flow rate of less than 2 cm³/min.

4. The tire according to claim 1, wherein the reinforcing elements of at least one layer of the carcass reinforcement are metal cords have, in what is called the permeability test, a flow rate of less than 20 cm³/min.

5. The tire according to claim 4, wherein the metal cords of at least one layer of the carcass reinforcement have, in what is called the permeability test, a flow rate of less than 20 cm³/min are cords having at least two layers and wherein at least one inner layer is sheathed with a layer consisting of a polymer composition such as a crosslinkable or crosslinked rubber composition, preferably based on at least one diene elastomer.

6. The tire according to claim 4, wherein said metal cords of at least one layer of the carcass reinforcement have, in what is called the permeability test, a flow rate of less than 10 cm³/min.

7. The tire according to claim 1, wherein said reinforcing elements of at least one stiffener are non-wrapped metal cords with saturated layers of [L+M] or [L+M+N] construction, comprising a first layer C1 having L threads of diameter d₁ where L ranges from 1 to 4, surrounded by at least one intermediate layer C2 having M threads of diameter d₂ wound together in a helix with a pitch P2 where M ranges from 3 to 12, said layer C2 being optionally surrounded by an outer layer C3 of N threads of diameter d₃ wound together in a helix with a pitch p₃, where N ranges from 8 to 20, and wherein a sheath consisting of a crosslinkable or crosslinked rubber composition based on at least one diene elastomer covers, in the [L+M] construction, said first layer C1 and, in the [L+M+N] construction, at least said layer C2.

8. The tire according to claim 1, wherein said reinforcing elements of at least one layer of the carcass reinforcement are layered metal cords of [L+M] or [L+M+N] construction, comprising a first layer C1 having L threads of diameter d₁ where L ranges from 1 to 4, surrounded by at least one intermediate layer C2 having M threads of diameter d₂ wound together in a helix with a pitch P2 where M ranges from 3 to 12, said layer C2 being optionally surrounded by an outer layer C3 of N threads of diameter d₃ wound together in a helix with a pitch p₃, where N ranges from 8 to 20, and wherein a sheath consisting of a crosslinkable or crosslinked rubber composition based on at least one diene elastomer covers, in the [L+M] construction, said first layer C1 and, in the [L+M+N] construction, at least said layer C2.

9. The tire according to claim 7, wherein the diameter of the threads of the first layer C1 is between 0.10 and 0.5 mm, and wherein the diameter of the threads of the layers C2, C3 is between 0.10 and 0.5 mm.

10. The tire according to claim 9, wherein the diameter of the threads of the layers C2, C3 is less than 0.22 mm.

11. The tire according to claim 7, wherein the helix pitch with which said threads of the outer layer C3 are wound is between 8 and 25 mm.

12. The tire according to claim 20, wherein said at least one diene elastomer is selected from the group consisting of polybutadienes, natural rubber, synthetic polyisoprenes, butadiene copolymers, isoprene copolymers and blends of these elastomers.

13. The tire according to claim 20, wherein the crosslinkable or crosslinked rubber composition based on at least one diene elastomer has, in the crosslinked state, a secant modulus in extension less than 20 MPa.

14. The tire according to claim 1, wherein the stiffener has a radially outer end that is radially on the outside of the end of the upturn.

15. The tire according to claim 1, wherein at least the end of the carcass reinforcement upturn is separated from the stiffener by at least one layer of polymer blend.

16. The tire according to claim 15, wherein the modulus of elasticity of the polymer blend in contact with the carcass reinforcement upturn and separating the stiffener from the end of the carcass reinforcement upturn is greater than 4 MPa.

17. The tire according to claim 1, the upturn of the carcass reinforcement being separated from the carcass reinforcement by a polymer blend positioned radially on the outside of the bead wire, wherein said polymer blend has a modulus of elasticity of greater than 4 MPa.

18. The tire according to claim 1, wherein the modulus of elasticity of polymer blends of calendering layers of the carcass reinforcement is less than or equal to 8 MPa.

19. The tire according to claim 2, wherein the polymer composition is a crosslinkable or crosslinked rubber composition.

20. The tire according to claim 19, wherein the crosslinkable or crosslinked rubber composition is based on at least one diene elastomer.

21. The tire according to claim 6, wherein the flow rate is less than 2 cm³/min.

22. The tire according to claim 8, wherein the diameter of the threads of the first layer C1 is between 0.10 and 0.5 mm, and wherein the diameter of the threads of the layers C2, C3 is between 0.10 and 0.5 mm.

23. The tire according to claim 22, wherein the diameter of the threads of the layers C2, C3 is less than 0.22 mm.

24. The tire according to claim 8, wherein the helix pitch with which said threads of the outer layer C3 are wound is between 8 and 25 mm.

25. The tire according to claim 13, wherein the secant modulus in extension is less than 20 MPa.
